(19) United States
(12) Patent Application Publication
(10) Pub. No.: US 2022/0272437 A1
(43) Pub. Date: Aug. 25, 2022

(54) IN-VEHICLE SPEAKER SYSTEM

(71) Applicant: SONY GROUP CORPORATION, TOKYO (JP)

(72) Inventors: ATSUSHI HOMMA, TOKYO (JP); KAZUTAKA KIMURA, TOKYO (JP); YOSHIHIRO OKIGAMI, TOKYO (JP)

(21) Appl. No.: 17/639,535

(22) PCT Filed: Jul. 15, 2020
(86) PCT No.: PCT/JP2020/027480

§ 371 Date: Mar. 1, 2022

(30) Foreign Application Priority Data
Sep. 9, 2019 (JP) 2019-163834

(51) Int. Cl. H04R 1/26; H04R 5/02; H04R 1/24

(52) U.S. Cl. CPC H04R 1/26; H04R 5/02; H04R 1/24; H04R 2499/13

(57) ABSTRACT

A plurality of exciters that outputs sound in a predetermined frequency band and a plurality of piezoelectric speakers that outputs sound in a frequency band higher than those of the exciters are provided, in which each of the plurality of exciters and the plurality of piezoelectric speakers is arranged in a space between an outer panel of a vehicle body and an interior member or on an inner surface side of the interior member, vibration generated in each of the exciters and the piezoelectric speakers is transmitted to the interior member, and a crossover frequency exists between a high range side in an output band of the exciters and a low range side in an output band of the piezoelectric speakers.

### TECHNICAL FIELD

The present technology relates to a technical field of an in-vehicle speaker system used in a vehicle.

### BACKGROUND ART

There is an in-vehicle speaker system having a speaker called an exciter used in a vehicle such as an automobile (see, for example, Patent Document 1 and Patent Document 2).

In the in-vehicle speaker systems described in Patent Document 1 and Patent Document 2, an example is illustrated in which an exciter is arranged between a roof (ceiling panel) that is a part of an outer panel and a roof trim that is a part of an interior member. By arranging the exciter between the outer panel and the interior member in this manner, an acoustic space by the in-vehicle speaker system is formed inside the vehicle without narrowing the vehicle interior space.

### CITATION LIST

### Patent Document

Patent Document 1: Japanese Patent Application Laid-Open No. 2014-75617
Patent Document 2: Japanese Patent Application Laid-Open No. 2006-173995

### SUMMARY OF THE INVENTION

### Problems to be Solved by the Invention

Incidentally, since the speaker constituting the in-vehicle speaker system is arranged between the outer panel and the interior member, it is possible to form the acoustic space without narrowing the vehicle interior space, but it is desirable to secure an output state of high-quality sound in this acoustic space.

In particular, it is desirable to provide an acoustic space in which high-quality sound is output in a wide frequency band (output band) from a low sound range to a high sound range and an immersive feeling is provided to a passenger in the vehicle interior.

Therefore, an object of the in-vehicle speaker system of the present technology is to form an acoustic space without narrowing a vehicle interior space and to secure an output state of high-quality sound in a wide frequency band from a low sound range to a high sound range.

### Solutions to Problems

First, an in-vehicle speaker system according to the present technology includes a plurality of exciters that outputs sound in a predetermined frequency band, and a plurality of piezoelectric speakers that outputs sound in a frequency band higher than those of the exciters, in which each of the plurality of exciters and the plurality of piezoelectric speakers is arranged in a space between an outer panel of a vehicle body and an interior member or on an inner surface side of the interior member, vibration generated in each of the exciters and the piezoelectric speakers is transmitted to the interior member, and a crossover frequency exists between a high range side in an output band of the exciters and a low range side in an output band of the piezoelectric speakers.

Thus, the plurality of exciters and the plurality of piezoelectric speakers that output sound in frequency bands in which at least a part of regions is different are arranged between the outer panel and the interior member, and sound is output in a wide frequency band by the exciters and the piezoelectric speakers.

Second, in the above-described in-vehicle speaker system, it is desirable that at least one of the exciters is arranged on a lowest side and at least one of the piezoelectric speakers is arranged on a highest side among the plurality of exciters and the plurality of piezoelectric speakers.

Thus, at least one of the exciters that output sound in a frequency band lower than those of the piezoelectric speakers among the plurality of exciters and the plurality of piezoelectric speakers is arranged on a lowest side, at least one of the piezoelectric speakers that output sound in a frequency band higher than those of the exciters among the plurality of exciters and the plurality of piezoelectric speakers is arranged on a highest side, and sound in the low sound range can be easily output from the lower side and sound in the high sound range can be easily output from the upper side.

Third, in the above-described in-vehicle speaker system, it is desirable that the at least one of the exciters is arranged on a lower side with reference to an upper surface of the dashboard and the at least one of the piezoelectric speakers is arranged on an upper side with reference to the upper surface of the dashboard.

Thus, at least one of the exciters that output sound in a frequency band lower than those of the piezoelectric speakers is positioned below the upper surface of the dashboard, and at least one of the piezoelectric speakers that output sound in a frequency band higher than those of the exciters is positioned above the upper surface of the dashboard, so that sound in a low sound range is easily output from the lower side and sound in a high sound range is easily output from the upper side.

Fourth, in the above-described in-vehicle speaker system, it is desirable that the exciters are arranged between a door panel provided as the outer panel and a door trim provided as the interior member.

Thus, since the exciters are arranged in the space between the door panel and the door trim, the degree of freedom of arrangement position of the exciters increases, and sound in a frequency band lower than those of the piezoelectric speakers is output from the lower side in the vehicle interior.

Fifth, in the above-described in-vehicle speaker system, it is desirable that the piezoelectric speakers are arranged between a pillar provided as the outer panel and a pillar trim provided as the interior member.

Thus, since the piezoelectric speaker is arranged in the space between the pillar and the pillar trim, the degree of freedom of arrangement positions of the piezoelectric speakers increases, and sound in a frequency band higher than those of the exciters is output from the upper side in the vehicle interior.

Sixth, in the above-described in-vehicle speaker system, it is desirable that a holding base that is at least partially elastically deformable and is attached to the interior member is provided, and the exciters are held by the holding base.

Thus, at least a part of the holding base is elastically deformed when the exciter is driven, and transmission of vibration from the exciter to the interior member is hardly inhibited by the holding base due to the elastic deformation.

Seventh, in the above-described in-vehicle speaker system, it is desirable that the holding base is provided with a base portion to which the exciters are attached and a plurality of arm portions that projects from the base portion and positioned on an outer peripheral side of the holding base, each of the plurality of arm portions is elastically deformable with respect to the base portion, and the plurality of arm portions is attached to the interior member.

Thus, the plurality of arm portions attached to the interior member is elastically deformed with respect to the base portion.

Eighth, in the above-described in-vehicle speaker system, it is desirable that the plurality of arm portions is formed in a shape along an outer periphery of the base portion.

Thus, the arm portion is positioned close to the base portion on the outer peripheral side of the base portion.

### BRIEF DESCRIPTION OF DRAWINGS

FIG. 1 illustrates an embodiment of an in-vehicle speaker system of the present technology together with FIGS. 2 to 15, and is a schematic perspective view of a vehicle.

FIG. 2 is a cross-sectional view illustrating a state where an exciter and a piezoelectric speaker are arranged in a space between an outer panel and an interior member.

FIG. 3 is a cross-sectional view illustrating a state where the exciter and the piezoelectric speaker are arranged in a space between an outer panel and an interior member at a position different from that in FIG. 2.

FIG. 4 is a perspective view illustrating an example of arrangement positions of exciters and piezoelectric speakers.

FIG. 5 is a diagram illustrating that a crossover frequency exists in a frequency band of the exciter and the piezoelectric speaker.

FIG. 6 is a perspective view of the exciter.

FIG. 7 is a perspective view illustrating a state where the exciter is attached to a holding base.

FIG. 8 is a cross-sectional view illustrating a state where the exciter is attached to an interior member with a holding base interposed therebetween.

FIG. 9 is a perspective view illustrating a state where the exciter is attached to another holding base.

FIG. 10 is a cross-sectional view illustrating a state where the exciter is attached to the interior member with another holding base interposed therebetween.

FIG. 11 illustrates measurement results regarding characteristics of the exciter together with FIG. 12, and is a diagram illustrating measurement results of frequency characteristics.

FIG. 12 is a diagram illustrating measurement results regarding sound pressure.

FIG. 13 is a perspective view of a piezoelectric speaker.

FIG. 14 is a perspective view illustrating a state where the piezoelectric speaker is pressed by a pressing member and attached to the interior member.

FIG. 15 is a perspective view illustrating a state where the piezoelectric speaker is pressed by another pressing member and attached to the interior member.

### MODE FOR CARRYING OUT THE INVENTION

Hereinafter, modes for implementing an in-vehicle speaker system of the present technology will be described with reference to the accompanying drawings.

Note that an in-vehicle speaker system described below is used in a vehicle such as an automobile, and when a direction is indicated in the following description, the direction is indicated with reference to up, down, front, rear, left, and right of the vehicle.

However, the front, rear, up, down, left, and right directions described below are for convenience of description, and the implementation of the present technology is not limited to these directions.

<Schematic Configuration of Vehicle>

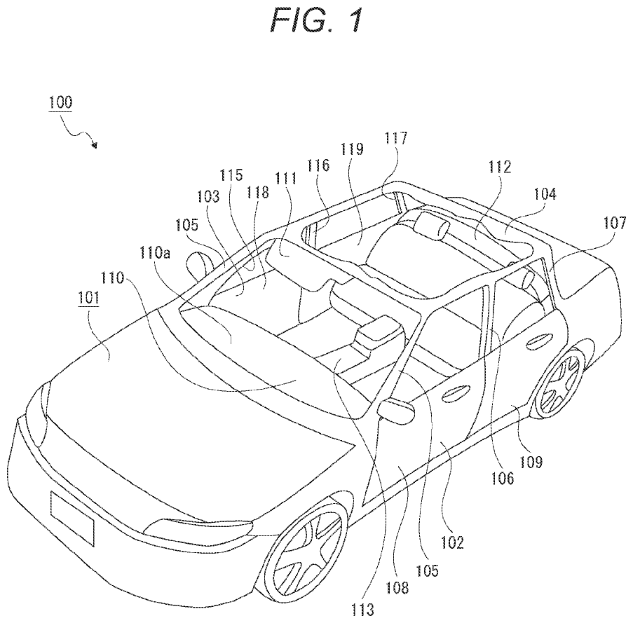

First, a schematic configuration of a vehicle 100 will be described (see FIGS. 1 to 3). Note that FIG. 1 illustrates the vehicle 100 by omitting a part of each unit arranged inside a vehicle interior.

A vehicle body 101 includes an outer panel 102 positioned on an outer surface side of the vehicle 100 and an interior member 103 provided in a vehicle interior, the outer panel 102 is mainly formed by a metal material having high strength, and an interior member 103 is mainly formed by a resin material (see FIG. 1).

The outer panel 102 includes a roof 104, front pillars (A pillars) 105 and 105, center pillars (B pillars) 106 and 106, rear pillars (C pillars) 107 and 107, front door panels 108 and 108, rear door panels 109 and 109, and the like.

In the vehicle interior, units such as a dashboard 110 arranged on a front side, a sun visor 111 positioned in front of an upper portion, a rear shelf 112 positioned on a rear side of a rear seat, and a console box 113 positioned between front seats are arranged.

The interior member 103 includes a roof trim 114, front pillar trims 115 and 115, center pillar trims 116 and 116, rear pillar trims 117 and 117, front door trims 118 and 118, rear door trims 119 and 119, and the like.

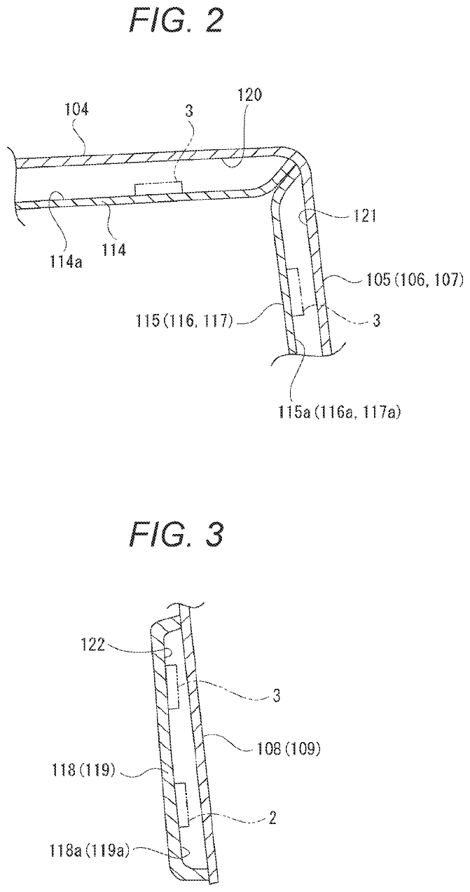

The roof trim 114 is positioned below the roof 104 (see FIG. 2). A space 120 is formed between the roof trim 114 and the roof 104.

The front pillar trims 115 and 115, the center pillar trims 116 and 116, and the rear pillar trims 117 and 117 are positioned inside the front pillars 105 and 105, the center pillars 106 and 106, and the rear pillars 107 and 107, respectively. Spaces 121, 121, and 121 are formed between the front pillar trims 115 and 115 and the front pillars 105 and 105, between the center pillar trims 116 and 116 and the center pillars 106 and 106, and between the rear pillar trims 117 and 117 and the rear pillars 107 and 107, respectively.

The front door trims 118 and 118 and the rear door trims 119 and 119 are positioned inside the front door panels 108 and 108 and the rear door panels 109 and 109, respectively (see FIG. 3). Spaces 122 and 122 are formed between the front door trims 118 and 118 and the front door panels 108 and 108 and between the rear door trims 119 and 119 and the rear door panels 109 and 109, respectively.

<Schematic Configuration of In-Vehicle Speaker System>

Next, a schematic configuration of the in-vehicle speaker system 1 will be described (see FIGS. 2 to 5).

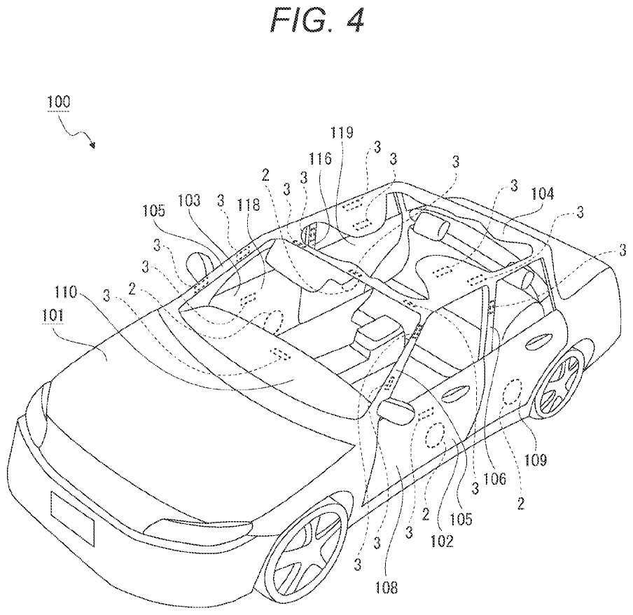

A plurality of exciters 2 and 2, . . . that outputs sound in a predetermined frequency band and a plurality of piezoelectric speakers 3 and 3, . . . that outputs sound in a frequency band in which at least a part of a region is different from those of the exciters 2 and 2, . . . are provided in the in-vehicle speaker system 1. The exciters 2 and 2, . . . and the piezoelectric speakers 3 and 3, . . . are arranged on an inner surface side of any one of the spaces 120, 121, and 122 formed between the outer panel 102 and the interior member 103 or the interior member 103 (see FIG. 4). Therefore, the exciters 2 and 2, . . . and the piezoelectric speakers 3 and 3, . . . are not arranged in the vehicle interior.

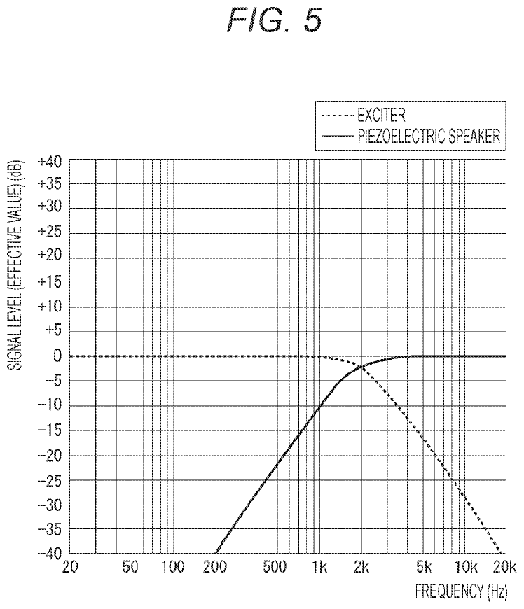

The exciter 2 has an output band of, for example, 30 Hz to 2 KHz, and the piezoelectric speaker 3 has an output band of, for example, 2 KHz to 25 KHz. There is a crossover frequency on a high range side in the output band of the exciters 2 and on a low range side in the output band of the piezoelectric speakers 3, for example, in the vicinity of 2 KHz (see FIG. 5).

As described above, in the in-vehicle speaker system 1, the exciters 2 and 2, . . . output sound in a frequency band from a low range to a mid range of about 2 KHz, and the piezoelectric speakers 3 and 3, . . . output sound in a frequency band from about 2 KHz to a high range, to thereby utilize respective characteristics of the exciters 2 and 2, . . . and the piezoelectric speakers 3 and 3, . . . to secure an output state of high quality sound.

For example, one exciter 2 is arranged in each of the spaces 122 and 122 formed between the front door trims 118 and 118 and the front door panels 108 and 108, and one exciter 2 is arranged in each of the spaces 122 and 122 formed between the rear door trims 119 and 119 and the rear door panels 109 and 109 (see FIG. 4).

The exciter 2 arranged in the space 122 is attached to an inner surface 118a of the front door trim 118 or an inner surface 119a of the rear door trim 119 with a holding base as described later interposed therebetween (see FIG. 3). A diaphragm is in contact with the inner surface 118a of the front door trim 118 or the inner surface 119a of the rear door trim 119.

When the exciter 2 is driven, vibration of the exciter 2 is transmitted to the front door trim 118 or the rear door trim 119, and the front door trim 118 or the rear door trim 119 vibrates to output sound to the vehicle interior. Therefore, in the interior member 103 of the vehicle interior, it is not necessary to provide a speaker grille for outputting sound from the exciter 2.

For example, three of the piezoelectric speakers 3 are arranged separately from each other on left and right sides at a front end portion in the space 120 formed between the roof trim 114 and the roof 104, one thereof is arranged at each of positions close to both left and right ends and at a position near a center in a front and rear direction in the space 120, and one thereof is arranged at each of both left and right end portions on a rear end side in the space 120 (see FIG. 4). Furthermore, for example, two of the piezoelectric speakers 3 are arranged vertically separately from each other in each of the spaces 121 formed between the front pillar trims 115 and 115 and the front pillars 105 and 105. Moreover, one of the piezoelectric speakers 3 is arranged, for example, in each of the spaces 121 formed between the center pillar trims 116 and 116 and the center pillars 106 and 106.

Furthermore, one of the piezoelectric speakers 3 is arranged, for example, in each of the spaces 122 and 122 formed between the front door trims 118 and 118 and the front door panels 108 and 108. The piezoelectric speaker 3 arranged in the space 122 is positioned above the exciter 2 also arranged in the space 122. Moreover, the piezoelectric speaker 3 is arranged, for example, at a center portion in a left-right direction in a space on a lower surface side of an upper surface portion 110a of the dashboard 110.

The piezoelectric speakers 3 arranged in the space 120 are attached to an inner surface 114a of the roof trim 114 (see FIG. 2). The piezoelectric speakers 3 arranged in the space 121 are attached to an inner surface 115a of the front pillar trim 115 or an inner surface 116a of the center pillar trim 116. The piezoelectric speakers 3 arranged in the space 122 are attached to an inner surface 118a of the front door trim 118. The piezoelectric speakers 3 arranged in the space on the lower surface side of the upper surface portion 110a of the dashboard 110 are attached to a lower surface of the upper surface portion 110a.

When the piezoelectric speakers 3 are driven, vibration of each of the piezoelectric speakers 3 is transmitted to the roof trim 114, the front pillar trims 115, the center pillar trims 116, the front door trims 118, and the dashboard 110, and each of the roof trim 114, the front pillar trims 115, the center pillar trims 116, the front door trims 118, and the dashboard 110 vibrate, so that sound is output to the vehicle interior. Therefore, in the interior member 103 of the vehicle interior, it is not necessary to provide a speaker grille for outputting sound from the piezoelectric speaker 3.

Note that for the piezoelectric speakers 3 and 3, . . . , types having different sizes according to arrangement positions may be used, and the piezoelectric speakers 3 and 3, . . . having different sizes may be arranged in the space 120, the spaces 121, or the spaces 122. Furthermore, it is desirable that the exciters 2 and 2, . . . and the piezoelectric speakers 3 and 3, . . . are respectively arranged at symmetrical positions in the vehicle 100.

Furthermore, at least one of the exciters 2 is arranged on a lowest side and at least one of the piezoelectric speakers 3 is arranged on a highest side among the exciters 2 and 2, . . . and the piezoelectric speakers 3 and 3, . . . in the in-vehicle speaker system 1.

Moreover, in the in-vehicle speaker system 1, at least one of the exciters 2 is arranged on a lower side with reference to an upper surface of the dashboard 110, and at least one of the piezoelectric speakers 3 is arranged on an upper side with reference to the upper surface of the dashboard 110.

Note that, although an example in which the exciters 2 and the piezoelectric speakers 3 are arranged in the spaces 120, 121, and 122 has been described above, the exciters 2 and the piezoelectric speakers 3 may be arranged in any space as long as it is a space between the outer panel 102 and the interior member 103 or a space on the inner surface side of the interior member 103. Furthermore, for example, it may be arranged on an inside of each unit or in a space inside each unit provided in the vehicle interior such as an inside of the sun visor 111, a space on a lower surface side of the rear shelf 112, an inside of the console box 113, or the like. Moreover, by arranging the exciter 2 or the piezoelectric speaker 3 in a space between the outer panel 102 and the interior member 103, it is also possible to configure such that sound is output from each unit provided in the vehicle interior that can be visually recognized by a passenger, for example, each unit indicative or figurative such that the passenger does not intend to output sound, such as an air outlet of the air conditioner, a cover of a light that emits light, or a portion with a logo.

<Configurations of Exciter and Holding Base>

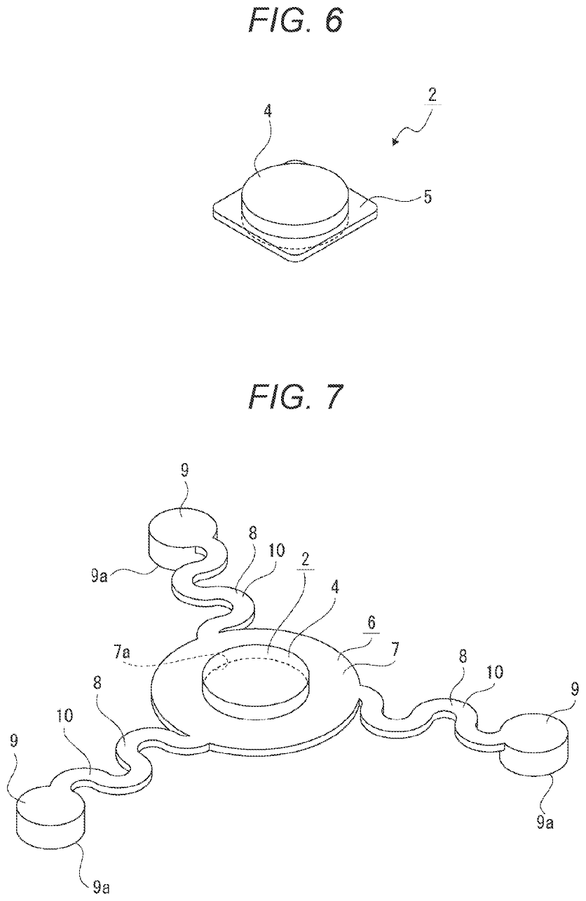

Next, configurations of the exciter 2 and a holding base that holds the exciter 2 will be described (see FIGS. 6 to 9).

The exciter 2 includes a main body portion 4 that outputs sound and a frame portion 5 that projects outward from the main body portion 4 (see FIG. 6).

The main body portion 4 is formed in a columnar outer shape, for example, and is provided with a sound output portion that includes a coil, a yoke, a magnet, and the like inside. The main body portion 4 is provided with a diaphragm at one end in the axial direction.

The frame portion 5 is formed in a flange shape, and an outer shape thereof is formed in, for example, a rectangular shape. The frame portion 5 is formed in a plate shape by a metal material or a resin material.

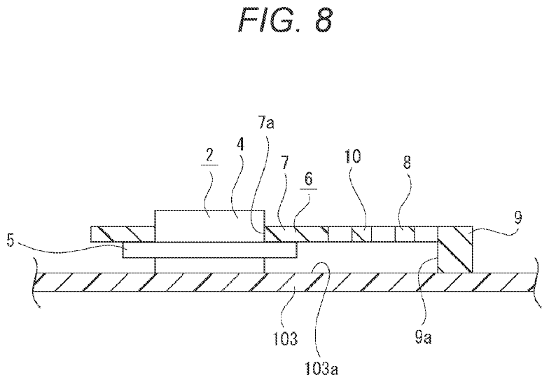

The exciter 2 is attached to an inner surface of the interior member 103, that is, an attachment surface 103a that is a surface on the outer panel 102 side of the interior member 103 with the holding base 6 interposed therebetween (see FIGS. 7 and 8). The holding base 6 is formed by integrally forming a base portion 7 formed in an annular shape and arm portions 8, 8, and 8 projecting outward from an outer peripheral surface of the base portion 7 with a resin material.

A center hole of the base portion 7 is formed as an insertion hole 7a. The frame portion 5 of the exciter 2 is attached to the base portion 7 by, for example, screwing or the like. In a state where the frame portion 5 is attached to the base portion 7, a part of the main body portion 4 is inserted through the insertion hole 7a and projects from the base portion 7 in the axial direction.

The arm portions 8, 8, and 8 are positioned separately at equal intervals in a circumferential direction, and are elastically deformable with respect to the base portion 7. The arm portions 8, 8, and 8 project in a radial direction with respect to the base portion 7. A distal end portion of an arm portion 8 is provided as a portion to be attached 9, and a portion other than the portion to be attached 9 is provided as a deformable portion 10. The deformable portion 10 is formed in, for example, a meandering shape. However, the deformable portion 10 may be formed in another shape such as a linear shape, and the shape is arbitrary.

Furthermore, although the number of the arm portions 8 is arbitrary as long as it is plural, it is desirable that at least three arm portions 8 are provided in order to maintain a stable attachment state of the holding base 6 and the exciter 2 to the interior member 103. Moreover, positions of the arm portions 8, 8, . . . with respect to the base portion 7 are desirably set at equal intervals in the circumferential direction in order to maintain a stable attachment state of the holding base 6 and the exciter 2 with respect to the interior member 103, but may be set at unequal intervals in the circumferential direction.

A part of the portion to be attached 9 is provided as a projecting portion 9a that projects with respect to the deformable portion 10 in the axial direction of the base portion 7.

In the holding base 6, in a state where the exciter 2 is attached to the base portion 7, the portion to be attached 9 is attached to the interior member 103 by screwing, adhesion, welding, or the like. The holding base 6 is attached to the interior member 103 in a state where a distal end surface of the projecting portion 9a of the portion to be attached 9 is in contact with the attachment surface 103a of the interior member 103, and the base portion 7 and the deformable portions 10, 10, and 10 have a constant interval with respect to the attachment surface 103a. Therefore, when the deformable portions 10, 10, and 10 are elastically deformed with respect to the base portion 7, the base portion 7 and the deformable portions 10, 10, and 10 do not come into contact with the interior member 103, and deformation of the deformable portions 10, 10, and 10 is not hindered.

In a state where the holding base 6 is attached to the interior member 103, the diaphragm of the exciter 2 is in contact with the attachment surface 103a. At this time, the diaphragm may be attached to the attachment surface 103a with a double-sided adhesive tape or the like.

Since the diaphragm of the exciter 2 is in contact with the attachment surface 103a in a state where the holding base 6 is attached to the interior member 103 as described above, vibration of the exciter 2 is transmitted to the interior member 103 when the exciter 2 is driven, and sound is output to the vehicle interior by the vibration of the interior member 103. Furthermore, at least a part of the holding base 6 is elastically deformed when the exciter 2 is driven, and transmission of vibration from the exciter 2 to the interior member 103 is hardly inhibited by the holding base 6 due to the elastic deformation. Therefore, after the exciter 2 is attached to the interior member 103 in a stable state with the holding base 6 interposed therebetween, high functionality of the exciter 2 related to sound output can be secured.

In particular, since the plurality of arm portions 8, 8, and 8 attached to the interior member 103 is elastically deformed with respect to the base portion 7, it is possible to secure a stable holding state of the exciter 2 with respect to the holding base 6 and to secure high functionality of the exciter 2 related to sound output.

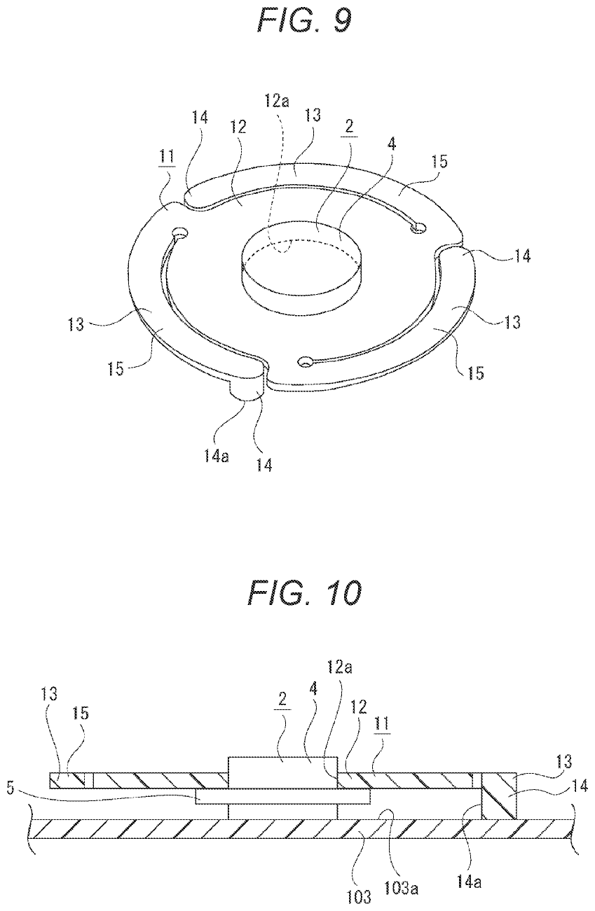

The exciter 2 may be attached to the attachment surface 103a of the interior member 103 with a holding base 11 interposed therebetween instead of the holding base 6 (see FIGS. 9 and 10). The holding base 11 is formed by integrally forming a base portion 12 formed in an annular shape and arm portions 13, 13, and 13 projecting from an outer peripheral surface of the base portion 12 with a resin material.

A center hole of the base portion 12 is formed as an insertion hole 12a. The frame portion 5 of the exciter 2 is attached to the base portion 12 by, for example, screwing or the like. In a state where the frame portion 5 is attached to the base portion 12, a part of the main body portion 4 is inserted through the insertion hole 12a and projects from the base portion 12 in the axial direction.

The arm portions 13, 13, and 13 are positioned separately at equal intervals in the circumferential direction and are elastically deformable with respect to the base portion 12. The arm portions 13, 13, and 13 are formed in an arc shape along an outer periphery of the base portion 12. A distal end portion of the arm portion 13 is provided as a portion to be attached 14, and a portion other than the portion to be attached 14 is provided as a deformable portion 15.

Although the number of the arm portions 13 is arbitrary as long as it is plural, it is desirable that at least three or more arm portions are provided in order to maintain a stable attachment state of the holding base 11 and the exciter 2 to the interior member 103. Furthermore, positions of the arm portions 13, 13, . . . with respect to the base portion 12 are desirably set at equal intervals in the circumferential direction in order to maintain a stable attachment state of the holding base 11 and the exciter 2 with respect to the interior member 103, but may be set at unequal intervals in the circumferential direction.

A part of the portion to be attached 14 is provided as a projecting portion 14a that projects with respect to the deformable portion 15 in the axial direction of the base portion 12.

In the holding base 11, in a state where the exciter 2 is attached to the base portion 12, the portion to be attached 14 is attached to the interior member 103 by screwing, adhesion, welding, or the like. The holding base 11 is attached to the interior member 103 in a state where a distal end surface of the projecting portion 14a of the portion to be attached 14 is in contact with the attachment surface 103a of the interior member 103, and the base portion 12 and the deformable portions 15, 15, and 15 have a constant interval with respect to the attachment surface 103a. Therefore, when the deformable portions 15, 15, and 15 are elastically deformed with respect to the base portion 12, the base portion 12 and the deformable portions 15, 15, and 15 do not come into contact with the interior member 103, and deformation of the deformable portions 15, 15, and 15 is not hindered.

In a state where the holding base 11 is attached to the interior member 103, the diaphragm of the exciter 2 is in contact with the attachment surface 103a. At this time, the diaphragm may be attached to the attachment surface 103a with a double-sided adhesive tape or the like.

Since the diaphragm of the exciter 2 is in contact with the attachment surface 103a in a state where the holding base 11 is attached to the interior member 103 as described above, vibration of the exciter 2 is transmitted to the interior member 103 when the exciter 2 is driven, and sound is output to the vehicle interior by the vibration of the interior member 103. Furthermore, at least a part of the holding base 11 is elastically deformed when the exciter 2 is driven, and transmission of vibration from the exciter 2 to the interior member 103 is hardly inhibited by the holding base 11 due to the elastic deformation. Therefore, after the exciter 2 is attached to the interior member 103 in a stable state with the holding base 11 interposed therebetween, high functionality of the exciter 2 related to sound output can be secured.

In particular, since the plurality of arm portions 13, 13, and 13 attached to the interior member 103 is elastically deformed with respect to the base portion 12, it is possible to secure a stable holding state of the exciter 2 with respect to the holding base 11 and to secure high functionality of the exciter 2 related to sound output.

Furthermore, since the arm portions 13, 13, and 13 of the holding base 11 are formed in a shape along the outer periphery of the base portion 12, the arm portions 13, 13, and 13 are positioned close to the base portion 12 on the outer peripheral side of the base portion 12, and the holding base 11 can be downsized.

Note that in the exciter 2 and the holding base 11, the frame portion 5 of the exciter 2 and the base portion 12 of the holding base 11 may be integrally formed, and the exciter 2 and the holding base 11 may constitute a speaker unit in which the frame portion 5 and the base portion 12 are integrally formed. By configuring such a speaker unit, reduction of the manufacturing cost by reducing the number of parts is possible and the process of attaching the frame portion 5 to the base portion 12 is unnecessary, and reduction of the manufacturing cost by reducing the number of work steps is possible.

Furthermore, such a configuration of the speaker unit can also be made in the exciter 2 and the holding base 6 described above, and in this case, the speaker unit includes the exciter 2 and the holding base 6 by integrally forming the frame portion 5 and the base portion 7.

Note that although the exciter 2 can be attached to the interior member 103 without using the holding base 6 or the holding base 11, in a case where the holding base 6 or the holding base 11 is not used, the diaphragm of the exciter 2 is attached to the interior member 103 by, for example, a double-sided adhesive tape. However, in a case where the double-sided adhesive tape is used, the double-sided adhesive tape is peeled off due to vibration generated during traveling of the vehicle 100 or an environmental change such as a temperature change in a space where the exciter 2 exists, and there is a possibility that a stable attachment state of the exciter 2 to the interior member 103 cannot be secured. Furthermore, in a case where the holding base 6 or the holding base 11 is not used, it is also assumed that the frame portion 5 of the exciter 2 is attached to the interior member 103 by screwing or the like. However, in a case where the frame portion 5 is attached to the interior member 103, since the frame portion 5 is a portion having high rigidity, vibration transmitted from the exciter 2 to the interior member 103 is hindered by attachment of the frame portion 5 having high rigidity to the interior member 103, and a problem such as not securing sufficient sound pressure of sound output from the exciter 2 may occur, and good characteristics of the exciter 2 may not be secured.

Therefore, as described above, by attaching the exciter 2 to the interior member 103 with the holding base 6 or the holding base 11 interposed therebetween, it is possible to ensure a stable attachment state of the exciter 2 to the interior member 103 and to secure good characteristics related to sound output of the exciter 2.

<Measurement Results Regarding Characteristics of Exciter>

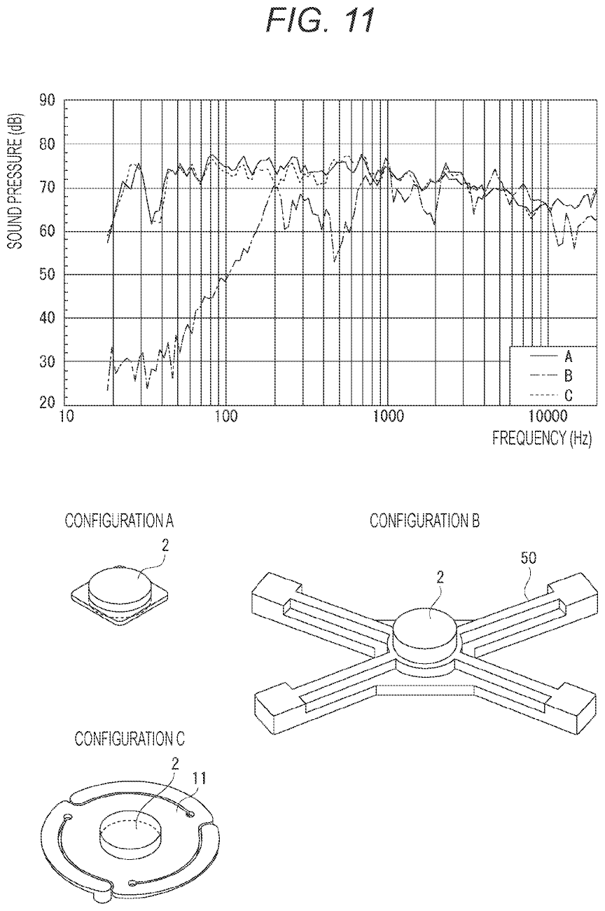

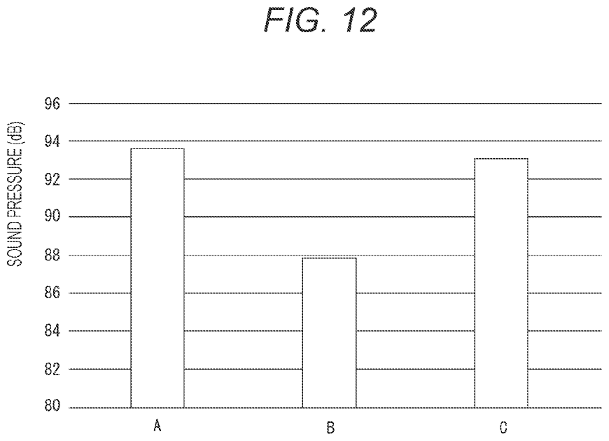

Hereinafter, measurement results regarding characteristics of the exciter 2 will be described (see FIGS. 11 and 12).

The measurement results are results of measuring frequency characteristics and sound pressure characteristics of the exciter 2 in a case where the exciter 2 is attached to the interior member 103 without using the holding base, a case where the exciter 2 is attached to the interior member 103 with the holding base 50 interposed therebetween, and a case where the exciter 2 is attached to the interior member 103 with the holding base 11 interposed therebetween. A measurement result A is a result of the case where the exciter 2 is attached to the interior member 103 without using the holding base, a measurement result B is a result of the case where the exciter 2 is attached to the interior member 103 with the holding base 50 interposed therebetween, and a measurement result C is a result of the case where the exciter 2 is attached to the interior member 103 with the holding base 11 interposed therebetween.

The holding base 50 is a rigid body and is provided as a member that does not elastically deform, and is formed in, for example, a cross shape, and four cross-shaped distal end portions are attached to the interior member 103.

FIG. 11 illustrates measurement results of frequency characteristics, where the horizontal axis represents frequency and the vertical axis represents sound pressure. In FIG. 11, the measurement result A and the measurement result C indicate that substantially equivalent characteristics are obtained, and the measurement result B indicates that the characteristics are deteriorated as compared with the measurement result A and the measurement result C.

In a case where the exciter 2 is attached to the interior member 103 with the holding base 11 interposed therebetween in this manner, characteristics equivalent to those obtained in the case where the exciter 2 is attached to the interior member 103 without using the holding base are obtained. Therefore, in the case where the exciter 2 is attached to the interior member 103 with the holding base 11 interposed therebetween, vibration transmitted from the exciter 2 to the interior member 103 is not inhibited, and high functionality of the exciter 2 related to sound output can be secured while securing a stable holding state of the exciter 2 with respect to the holding base 11.

On the other hand, in the case where the exciter 2 is attached to the interior member 103 with the holding base 50 that is a rigid body interposed therebetween, a result is obtained in which characteristics are deteriorated as compared with the case where the exciter 2 is attached to the interior member 103 with the holding base 11 interposed therebetween. Therefore, in the case where the exciter 2 is attached to the interior member 103 with the holding base 50 interposed therebetween, vibration transmitted from the exciter 2 to the interior member 103 is inhibited by the holding base 50, and high functionality of the exciter 2 cannot be secured. In particular, the exciter 2 is a speaker that plays a role of responsible for a band with an output band of 30 Hz to 2 KHz, but in a case where the exciter 2 is attached to the interior member 103 with the holding base 50 interposed therebetween, the characteristics are deteriorated in substantially the entire region of the band of 30 Hz to 2 KHz, and it is understood that high functionality of the exciter 2 cannot be secured.

FIG. 12 illustrates a measurement result regarding the sound pressure, and the vertical axis indicates the sound pressure. In FIG. 12, a measurement result A and a measurement result C indicate that substantially equal sound pressure is obtained, and a measurement result B indicates that the sound pressure is lower than the measurement result A and the measurement result C.

In the case where the exciter 2 is attached to the interior member 103 with the holding base 11 interposed therebetween in this manner, a sound pressure equal to that in the case where the exciter 2 is attached to the interior member 103 without using the holding base is obtained. Therefore, in the case where the exciter 2 is attached to the interior member 103 with the holding base 11 interposed therebetween, vibration transmitted from the exciter 2 to the interior member 103 is not inhibited, and high functionality of the exciter 2 related to sound output can be secured while securing a stable holding state of the exciter 2 with respect to the holding base 11.

On the other hand, in the case where the exciter 2 is attached to the interior member 103 with the holding base 50 that is a rigid body interposed therebetween, a result is obtained in which the sound pressure is reduced by about 6 dB as compared with the case where the exciter 2 is attached to the interior member 103 with the holding base 11 interposed therebetween. Therefore, it is understood that in the case where the exciter 2 is attached to the interior member 103 with the holding base 50 interposed therebetween, vibration transmitted from the exciter 2 to the interior member 103 is inhibited by the holding base 50, and high functionality of the exciter 2 cannot be secured.

<Configuration of Piezoelectric Speaker and Pressing Member>

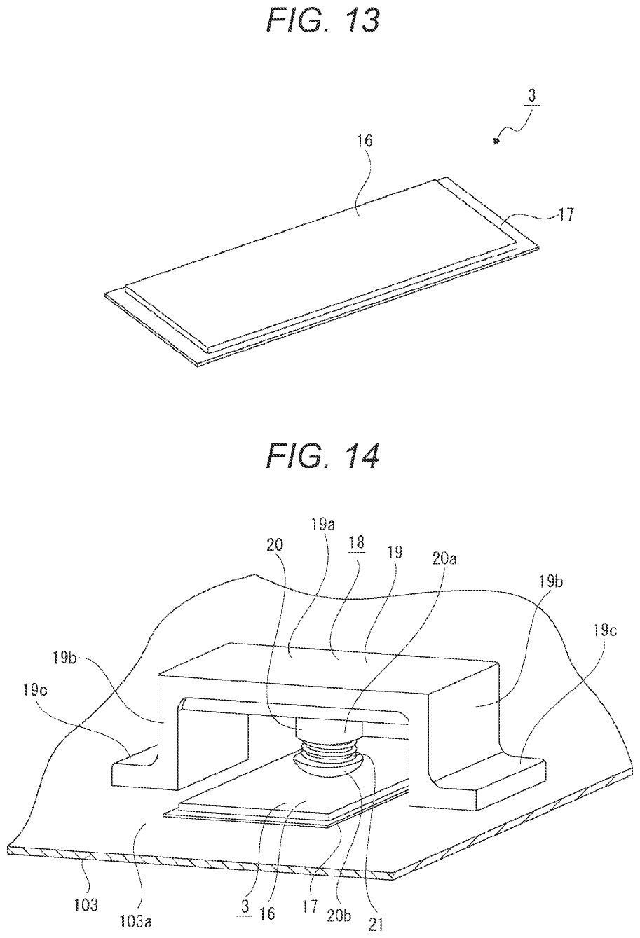

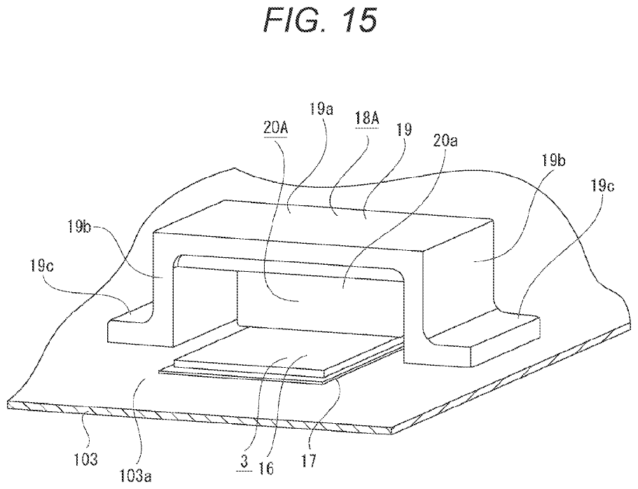

Next, a configuration of the piezoelectric speaker 3 and a pressing member that presses the piezoelectric speaker 3 will be described (see FIGS. 13 to 15).

The piezoelectric speaker 3 includes a vibration generation unit 16 that is bent by application of a voltage to output sound and a holding plate portion 17 to which the vibration generation unit 16 is attached (see FIG. 13). The piezoelectric speaker 3 is attached to the interior member 103 in a state where the holding plate portion 17 is in contact with the attachment surface 103a.

The vibration generation unit 16 is formed in a flat rectangular shape, and is formed by stacking a plurality of piezoelectric elements in a longitudinal direction. When a voltage is applied, the vibration generation unit 16 is bent (deformed) in a thickness direction and vibrates.

The base plate 17 is formed by a metal material in a thin plate shape slightly larger than the vibration generation unit 16, and is bent as the vibration generation unit 16 is bent.

The piezoelectric speaker 3 is attached to the attachment surface 103a of the interior member 103 in a state of being pressed by a pressing member 18 (see FIG. 14). The pressing member 18 includes a bracket portion 19 and a pressing projecting portion 20.

The bracket portion 19 includes a base plate portion 19a having a substantially rectangular shape, connecting portions 19b and 19b projecting in the same direction orthogonal to both end portions of the base plate portion 19a in the longitudinal direction, and portions to be attached 19c and 19c projecting in an opposite direction orthogonal to the connecting portions 19b and 19b.

The pressing projecting portion 20 includes a support shaft portion 20a projecting from a center portion of the base plate portion 19a in the same direction as the connecting portions 19b, and a pressing portion 20b movable in an axial direction of the support shaft portion 20a on the support shaft portion 20a. An urging spring 21 is supported by the pressing projecting portion 20, and the pressing portion 20b is urged in a direction away from the support shaft portion 20a by the urging spring 21.

In the pressing member 18, the portions to be attached 19c and 19c of the bracket portion 19 are attached to the interior member 103 by screwing, adhesion, welding, or the like. At this time, the piezoelectric speaker 3 is in a state where the holding plate portion 17 is in contact with the attachment surface 103a, and is attached to the interior member 103 in a state where a center portion in the longitudinal direction of the vibration generation unit 16 is pressed by the pressing portion 20b urged by the urging spring 21 and pressed against the attachment surface 103a.

In a state where the piezoelectric speaker 3 is attached to the interior member 103, when the piezoelectric speaker 3 is driven, vibration of the piezoelectric speaker 3 is transmitted to the interior member 103, and the interior member 103 vibrates to output sound to the vehicle interior. In a state where the piezoelectric speaker 3 is attached to the interior member 103, since the vibration generation unit 16 is pressed against the attachment surface 103a by the pressing portion 20b, vibration is transmitted from the piezoelectric speaker 3 to the interior member 103 in a stable state. Therefore, after the piezoelectric speaker 3 is attached to the interior member 103 in a stable state while being pressed by the pressing member 18, high functionality of the piezoelectric speaker 3 related to sound output can be secured.

Furthermore, since the pressing portion 20b of the pressing member 18 is urged by the urging spring 21, the piezoelectric speaker 3 can be reliably pressed against the attachment surface 103a by the pressing portion 20b.

Note that the piezoelectric speaker 3 may be attached to the attachment surface 103a with a double-sided adhesive tape or the like. In this case, by the double-sided adhesive tape or the like, the entire holding plate portion 17 of the piezoelectric speaker 3 may be attached to the attachment surface 103a, or a part of the holding plate portion 17 may be attached to the attachment surface 103a. In a case where a part of the holding plate portion 17 is attached to the attachment surface 103a, for example, both end portions of the holding plate portion 17 in the longitudinal direction and a center portion thereof in the longitudinal direction are desirably attached.

Although the example of the pressing member 18 having the urging spring 21 has been described above, it is also possible to use a pressing member 18A not having the urging spring 21 instead of the pressing member 18. The pressing member 18A is provided with a pressing projecting portion 20A, and the pressing projecting portion 20A projects from the center portion in the longitudinal direction of the base plate portion 19a. The size of the pressing projecting portion 20A in a lateral direction of the base plate portion 19a is substantially the same as the width of the piezoelectric speaker 3 in the lateral direction.

In the pressing member 18A, the portions to be attached 19c and 19c of the bracket portion 19 are attached to the interior member 103 by screwing, adhesion, welding, or the like. The piezoelectric speaker 3 is attached to the interior member 103 in a state where the entire center portion in the longitudinal direction of the vibration generation unit 16 is pressed by the pressing projecting portion 20A and pressed against the attachment surface 103a. As described above, the piezoelectric speaker 3 is pressed by the pressing projecting portion 20 across the entire width direction of the center portion in the longitudinal direction of the vibration generation unit 16. Therefore, the piezoelectric speaker 3 is reliably pressed against the attachment surface 103a by the pressing member 18A, and a stable attachment state of the piezoelectric speaker 3 to the interior member 103 can be secured.

As described above, since the piezoelectric speaker 3 is pressed against the attachment surface 103a by the pressing member 18 or the pressing member 18A, it is possible to prevent the piezoelectric speaker 3 from falling off the interior member 103, and to transmit vibration from the piezoelectric speaker 3 to the interior member 103 in a stable state.

<Summary>

As described above, in the in-vehicle speaker system 1, each of a plurality of exciters 2 and a plurality of piezoelectric speakers 3 is arranged between the outer panel 102 of the vehicle body 101 and the interior member 103, vibration generated in each of the exciters 2 and the piezoelectric speakers 3 is transmitted to the interior member 103, and a crossover frequency exists between the high range side in the output band of the exciters 2 and the low range side in the output band of the piezoelectric speakers 3.

Therefore, the plurality of exciters 2 and the plurality of piezoelectric speakers 3 that output sound in frequency bands in which at least a part of regions is different are arranged between the outer panel 102 and the interior member 103, and sound is output in a wide frequency band by the exciters 2 and the piezoelectric speakers 3. Thus, it is possible to form an acoustic space without narrowing the vehicle interior space and then to secure an output state of high-quality sound in a wide frequency band from a low sound range to a high sound range.

In particular, by using the exciters 2 that output sound in the low range to the mid range, a speaker that outputs sound in the low range such as a heavy woofer or subwoofer is not required, and by using the piezoelectric speakers 3 that output sound in the mid range to the high range together with the exciters 2, it is possible to secure an output state of high-quality sound in the wide frequency band from the low sound range to the high sound range while reducing the weight by not separately providing a speaker such as a woofer or a subwoofer.

Furthermore, since the piezoelectric speakers 3 are speakers that output sound by voltage driving, have a low impedance, and do not need to pass a large current, the wire diameter of a cable connected to the piezoelectric speakers 3 is small, and accordingly, low weight of the in-vehicle speaker system 1 can be achieved. In particular, in a system used for the vehicle 100 such as the in-vehicle speaker system 1, a long cable of 5m or more may be required depending on the positional relationship between the piezoelectric speakers 3 and an amplifier, but since the wire diameter is small, low weight by a significant weight reduction can be achieved, and fuel efficiency of the vehicle 100 can be improved.

Moreover, since the piezoelectric speakers 3 are surface sound sources, directivity in the high range is high, and it is possible that sufficiently high quality sound can be heard without making the sound volume large.

Furthermore, at least one of the exciters 2 is arranged on a lowest side and at least one of the piezoelectric speakers 3 is arranged on a highest side among the exciters 2 and 2, . . . and the piezoelectric speakers 3 and 3, . . . in the in-vehicle speaker system 1.

In such an arrangement state, at least one of the exciters 2 that output sound in a frequency band lower than those of the piezoelectric speakers 3 among the exciters 2 and 2, . . . and the piezoelectric speakers 3 and 3, . . . is arranged on a lowest side, and at least one of the piezoelectric speakers 3 that output sound in a frequency band higher than those of the exciters 2 among the exciters 2 and 2, . . . and the piezoelectric speakers 3 and 3, . . . is arranged on a highest side.

Therefore, sound in the low sound range can be easily output from the lower side, and sound in the high sound range can be easily output from the upper side, so that the output state of high-quality sound in the vehicle interior can be secured.

Moreover, in the in-vehicle speaker system 1, at least one of the exciters 2 is arranged on a lower side with reference to an upper surface of the dashboard 110, and at least one of the piezoelectric speakers 3 is arranged on an upper side with reference to the upper surface of the dashboard 110.

Therefore, at least one of the exciters 2 that output sound in a frequency band lower than those of the piezoelectric speakers 3 is positioned below the upper surface of the dashboard 110, and at least one of the piezoelectric speakers 3 that output sound in a frequency band higher than those of the exciters 2 is positioned above the upper surface of the dashboard 110. Thus, sound in the low sound range can be easily output from the lower side, and sound in the high sound range can be easily output from the upper side, so that the output state of the higher-quality sound in the vehicle interior can be secured.

Moreover, the exciters 2 are arranged between the door panels 108 and 109 provided as the outer panel 102 and the door trims 118 and 119 provided as the interior member 103.

Therefore, since the exciters 2 are arranged in the space 122 between the door panels 108 and 109 and the door trims 118 and 119, the degree of freedom of arrangement positions of the exciters 2 increases and sound in a frequency band lower than those of the piezoelectric speakers 3 is output from the lower side in the vehicle interior, and it is possible to secure an output state of high-quality sound while improving the degree of freedom of design regarding the arrangement positions of the exciters 2.

In addition, the piezoelectric speakers 3 are arranged between pillars 105 and 106 provided as the outer panel 102 and pillar trims 115 and 116 provided as the interior member 103.

Therefore, since the piezoelectric speaker 3 is arranged in the space between the pillars 105 and 106 and the pillar trims 115 and 116, the degree of freedom of arrangement positions of the piezoelectric speakers 3 increases and sound in a frequency band higher than those of the exciters 2 is output from the upper side in the vehicle interior, and it is possible to secure an output state of high-quality sound while improving the degree of freedom of design regarding the arrangement positions of the piezoelectric speakers 3.

<Present Technology>

The present technology can be configured as follows.

(1)

An in-vehicle speaker system including:

a plurality of exciters that outputs sound in a predetermined frequency band; and

a plurality of piezoelectric speakers that outputs sound in a frequency band higher than those of the exciters,

in which each of the plurality of exciters and the plurality of piezoelectric speakers is arranged in a space between an outer panel of a vehicle body and an interior member or on an inner surface side of the interior member,

vibration generated in each of the exciters and the piezoelectric speakers is transmitted to the interior member, and

a crossover frequency exists between a high range side in an output band of the exciters and a low range side in an output band of the piezoelectric speakers.

(2)

The in-vehicle speaker system according to (1) above, in which

at least one of the exciters is arranged on a lowest side and at least one of the piezoelectric speakers is arranged on a highest side among the plurality of exciters and the plurality of piezoelectric speakers.

(3)

The in-vehicle speaker system according to (1) or (2) above, in which

the at least one of the exciters is arranged on a lower side with reference to an upper surface of the dashboard and the at least one of the piezoelectric speakers is arranged on an upper side with reference to the upper surface of the dashboard.

(4)

The in-vehicle speaker system according to any one of (1) to (3) above, in which

the exciters are arranged between a door panel provided as the outer panel and a door trim provided as the interior member.

(5)

The in-vehicle speaker system according to any one of (1) to (4) above, in which

the piezoelectric speakers are arranged between a pillar provided as the outer panel and a pillar trim provided as the interior member.

(6)

The in-vehicle speaker system according to any one of (1) to (5) above, in which

a holding base that is at least partially elastically deformable and is attached to the interior member is provided, and

the exciters are held by the holding base.

(7)

The in-vehicle speaker system according to (6) above, in which

the holding base is provided with a base portion to which the exciters are attached and a plurality of arm portions that projects from the base portion and positioned on an outer peripheral side of the holding base,

each of the plurality of arm portions is elastically deformable with respect to the base portion, and

the plurality of arm portions is attached to the interior member.

(8)

The in-vehicle speaker system according to (7) above, in which

the plurality of arm portions is formed in a shape along an outer periphery of the base portion.

### REFERENCE SIGNS LIST

101 Vehicle body
102 Outer panel
103 Interior member
110 Dashboard
114 Roof trim
114a Inner surface
115 Front pillar trim
115a Inner surface
116 Center pillar trim
116a Inner surface
117 Rear pillar trim
117a Inner surface
118 Front door trim
118a Inner surface
119 Rear door trim
119a Inner surface
120 Space (roof)
121 Space (pillar)
122 Space (door)
1 In-vehicle speaker system
2 Exciter
3 Piezoelectric speaker
6 Holding base
7 Base portion
8 Arm portion
11 Holding base
12 Base portion
13 Arm portion

1. An in-vehicle speaker system comprising:
a plurality of exciters that outputs sound in a predetermined frequency band; and
a plurality of piezoelectric speakers that outputs sound in a frequency band higher than those of the exciters,
wherein each of the plurality of exciters and the plurality of piezoelectric speakers is arranged in a space between an outer panel of a vehicle body and an interior member or on an inner surface side of the interior member,
vibration generated in each of the exciters and the piezoelectric speakers is transmitted to the interior member, and
a crossover frequency exists between a high range side in an output band of the exciters and a low range side in an output band of the piezoelectric speakers.

2. The in-vehicle speaker system according to claim 1, wherein
at least one of the exciters is arranged on a lowest side and at least one of the piezoelectric speakers is arranged on a highest side among the plurality of exciters and the plurality of piezoelectric speakers.

3. The in-vehicle speaker system according to claim 1, wherein
the at least one of the exciters is arranged on a lower side with reference to an upper surface of the dashboard and the at least one of the piezoelectric speakers is arranged on an upper side with reference to the upper surface of the dashboard.

4. The in-vehicle speaker system according to claim 1, wherein
the exciters are arranged between a door panel provided as the outer panel and a door trim provided as the interior member.

5. The in-vehicle speaker system according to claim 1, wherein
the piezoelectric speakers are arranged between a pillar provided as the outer panel and a pillar trim provided as the interior member.

6. The in-vehicle speaker system according to claim 1, wherein
a holding base that is at least partially elastically deformable and is attached to the interior member is provided, and
the exciters are held by the holding base.

7. The in-vehicle speaker system according to claim 6, wherein
the holding base is provided with a base portion to which the exciters are attached and a plurality of arm portions that projects from the base portion and positioned on an outer peripheral side of the holding base,
each of the plurality of arm portions is elastically deformable with respect to the base portion, and
the plurality of arm portions is attached to the interior member.

8. The in-vehicle speaker system according to claim 7, wherein
the plurality of arm portions is formed in a shape along an outer periphery of the base portion.
